(19) United States
(12) Patent Application Publication
(10) Pub. No.: US 2003/0219696 A1
(43) Pub. Date: Nov. 27, 2003

(54) Method and apparatus for preventing backflow in dental saliva evacuators

(76) Inventor: Gerald W. Moreland, Orange, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/155,875

(22) Filed: May 23, 2002

(51) Int. Cl. A61C 17/14

(52) U.S. Cl. 433/95; 433/91

(57) ABSTRACT

A method and valve are disclosed for preventing bacterial contamination from being introduced by backflow from a saliva evacuator, particularly cross contamination of dental patients by previous patients as well as contamination from biofilm which is growing in the lines. The backflow may contain bacteria, viruses and other pathogens from previous patients or from the biofilm contamination of the lines.

### FIELD OF THE INVENTION

The invention relates to a method and apparatus for preventing backflow in saliva evacuators. More specifically, a check valve or one-way valve, such as a duckbill valve is provided for the saliva evacuator which allows the flow of liquid in only one direction.

### BACKGROUND OF THE INVENTION

Growing evidence suggests that saliva and blood from dental procedures can be passed from one patient to another through the aspiration tubes. Several studies have found that the saliva evacuator which aspirates saliva from the patient's mouth can reverse its flow and deposit fluids from past patients into subsequent patients' mouths. Often this happens when patients' lips are closed around the tube, although it may occur when the ejector is blocked off by the tongue or cheek.

The saliva evacuator also called a vacuum handpiece, saliva ejector, saliva evacuator and/or aspirator is a vacuum powered suction device that keeps the mouth clear of fluid during dental procedures such as cleaning. When in use, a disposable ejector tip is fitted onto the vacuum tube and left in the patients' mouth during the procedure to aspirate saliva, blood or other liquid and allow a clear working area for the dentist/hygenist. A disposable evacuation/ejector tip fits in the vacuum tube and is replaced after each patient. However if the vacuum tube is not disinfected between patients, bacteria from the first patient can survive and potentially be expelled into the mouth of the next patient. When the mouth is closed, an airtight seal can be formed. As the air pressure decreases, the vacuum power increases in the mouth. The vacuum power in the mouth eventually overwhelms the vacuum power of the suction tube and the flow of liquid and bacteria reverses back into the mouth.

This fluid may contain on average in excess of 54,000 microorganisms per milliliter, including both facultative and obligate anaerobic bacteria of medium to high virulence. Other infectious agents including Streptococcus, hepatitis B, herpes virus, influenza virus, and other upper respiratory viruses may also be present. This germ laden water may then be sprayed into the mouth of the next patient, possibly initiating an oral or upper respiratory tract infection. Sterilizing the vacuum tube between appointments, although of great significance in the prevention of disease transmission, will not totally eliminate the problem discussed here as some of the oral fluid aspirated into the dental unit goes into the vacuum line and the bacteria and other pathogens may become permanent residents in the form of a biofilm.

Thus, a method for preventing backflow in saliva evacuator is needed. The method needs to be simple, inexpensive and modifiable to a variety of makes and types of dental equipment.

### SUMMARY OF THE INVENTION

A method and an apparatus for preventing backflow in saliva evacuators is provided herein. The apparatus includes a check valve or one-way valve, such as a duckbill valve which is a reliable non return valve which reduces the risk of bacteria ingress to the handpiece.

One embodiment is an apparatus for preventing a contaminated fluid from entering a patient's mouth through a saliva evacuator, the apparatus being a check valve positioned in the fluid flow path of a saliva evacuator, the check valve permitting flow away from the patient's mouth, but not toward the patient's mouth. Preferably the check valve is a duckbill valve. Preferably, the duckbill valve is manufactured from materials such as, elastomers, rubbery polymers, nylons, polyesters, PTFE, HDPE, PMMA, PVC, PP, PF, PC, and polymides. Preferably the elastomer is a silicone and the rubbery polymer is soft butyl, or hard butyl.

In one embodiment, the check valve is located at the junction of the sterile and non-sterile portions of the saliva evacuator.

A further embodiment is a method for preventing contaminated fluid from a dental unit water line from entering a patient's mouth, by inserting a check valve into a saliva evacuator, such that the check valve permits flow away from but not toward the patient's mouth. Preferably, the check valve is a duckbill valve. Preferably, the duckbill valve is the duckbill valve described herein. Preferably, the check valve is located at the junction of the sterile and non-sterile portions of the saliva evacuator.

A further embodiment is an apparatus for preventing a contaminated fluid from entering a patient's mouth through a saliva evacuator, which is: a check valve positioned in the fluid flow path of an adapter attached to a saliva evacuator, such that the check valve permits flow away from the patient's mouth, but not toward the patient's mouth. Preferably the check valve is a duckbill valve. Preferably, the duckbill valve is manufactured from materials such as, elastomers, rubbery polymers, nylons, polyesters, PTFE, HDPE, PMMA, PVC, PP, PF, PC, and polymides. Preferably the elastomer is a silicone and the rubbery polymer is soft butyl, or hard butyl.

In one embodiment, the check valve is located at the junction of the sterile and non-sterile portions of the saliva evacuator.

A further embodiment is a method for preventing contaminated fluid in a dental unit water line from entering a patient's mouth, by inserting a check valve into an adapter attached to a saliva evacuator, such that the check valve permits flow away from but not toward the patient's mouth. Preferably, the check valve is a duckbill valve. Preferably, the duckbill valve is the duckbill valve described herein. Preferably, the check valve is located at the junction of the sterile and non-sterile portions of the saliva evacuator.

Further aspects, features and advantages of this invention will become apparent from the detailed description of the preferred embodiments which follow.

### BRIEF DESCRIPTION OF THE DRAWINGS

FIG. 1A is a top perspective view of a typical dental chair, including the saliva evacuators and the vacuum lines. FIG. 1B is a blown-up view of the saliva evacuators.

FIG. 2 is a perspective view of a saliva evacuator, an adapter/connector, and a vacuum tube.

FIG. 3 is a side view of a saliva evacuator and an adapter/connector.

FIG. 4 is a cross-sectional side view of a duckbill valve of the preferred embodiments placed within the adapter/connector.

FIGS. 5A-F show various views of a duckbill valve of the preferred embodiments. FIG. 5A is a sideview, FIG. 5B is a front view, FIG. 5C is a perspective view, FIG. 5D is a bottom view, FIG. 5E is a back view of the closed duckbill valve, and FIG. 5F is a back view of the open duckbill valve.

### DETAILED DESCRIPTION OF THE PREFERRED EMBODIMENT

A method and apparatus is disclosed herein which prevents backflow in saliva evacuators also referred to as vacuum or dental handpieces. The phrase, saliva evacuator is used herein to refer to a vacuum handpiece, saliva ejector, saliva evacuator and/or saliva aspirator all of which refer to a vacuum powered suction device that keeps the mouth clear of fluid during dental procedures such as cleaning. The preventative apparatus is simple, inexpensive and can be modified to fit any saliva evacuator which is commercially available.

A variety of saliva evacuators are available to allow for the attachment of different ejector tips. The saliva evacuator may be attached to the vacuum lines using a connector/adapter device or may be attached directly. Then, disposable saliva ejector tips can be attached at the other end to allow for aspiration from the patient's mouth. These ejector tips may be of various shapes and sizes depending on the amount of liquid which will be removed, the size of the area from which the liquid will be removed and the speed with which the liquid will be removed. Typically the ejector tips are composed of a clear or clear-colored plastic tube with a tip to assure maximum patient safety. However, the surgical tips are often opaque to mask the aspirated fluid. There are smaller tips to allow removal from a smaller area and larger tips for quick removal or removal from a larger area. HVE tips are typically larger because they are used to remove tissue and larger foreign objects.

During a procedure, the ejector tip is left in a patient's mouth to aspirate saliva, blood or other liquid and allow a clear working area for the dentist/hygenist. However, under some conditions an airtight seal can unintentionally be formed. If the vacuum tube is not disinfected between patients, bacteria from the first patient can survive and potentially be expelled into the mouth of the next patient. This occurs because the vacuum power in the mouth eventually overwhelms the vacuum power of the suction tube and the flow of liquid and bacteria reverses back into the mouth.

The bacteria from the vacuum tube may include free bacteria as well as bacteria which is a part of the biofilm which forms on the vacuum tube. Biofilms are microbial communities that adhere to solid surfaces wherever there is sufficient moisture, including plant and animal tissues. Consisting primarily of bacteria, biofilms often exhibit astonishingly complex communal architecture. Most biofilms are heterogeneous in species and morphology and protect the organisms within from desiccation, chemical insult and predation, as well as from attacks by plant and animal immune systems. The relationship between biofilm organisms is often symbiotic, with one species providing key cofactors required by another. Biofilms also provide an environment conducive to the proliferation of a wide variety of other microscopic life, including fungi, algae, protozoa and nematodes. Absent the algae and nematodes, dental plaque is a classic biofilm.

In addition, dental units can sometimes retract oral flora from a patient's mouth and, although these organisms typically need a warm, nutrient-rich oral environment to survive, they may survive in the biofilms. Although most of the microbes contributing to the biofilm are not pathogenic, if a patient is frail, ill, asthmatic, or immunocompromised, even those typically nonpathogenic microorganisms can cause disease.

There is a risk to the patient because a potential hazard exists whenever high numbers of exogenous microorganisms with pathogenic potential are introduced into an anatomical region which possesses four available portals of entry (respiratory, gastrointestinal, mucous membrane, and vascular). The rationale for preventing backflow in dental evacuators can be found in the concept of the chain of infection and in the doctrine of informed consent.

Clinical infection control procedures focus on breaking the “chain of infection”. The “chain of infection” requires sufficient numbers of potentially pathogenic organisms, a mode of transmission, a portal of entry, and a susceptible host. Most infection control measures target elimination or isolation of microbes in the clinical environment. Dental practices expend great effort and expense in accomplishing this goal as an everyday matter through the use of procedures including surface disinfection, instrument sterilization, handwashing, and antimicrobial mouthrinsing.

Thus, because all of the criteria in the chain of infection are met in the dental setting, it is important that backflow in the aspirators does not increase the risk to unacceptable levels. Particularly because, the process of dentistry creates cuts or openings for the organism to enter, patients may be ill or immunocompromised, and many of the microorganisms found in biofilms may cause disease under the right circumstances.

In addition, healthcare providers have an obligation to assure the safety of patients entrusted to their care by providing the safest possible clinical environment.

Some of the most worrisome microbes which are commonly found in biofilms include: Pseudomonas aeruginosa, the cause of nosocomial pneumonia (50% mortality) and a frequent cause of death in cystic fibrosis patients, Legionella pneumophila, an intracellular parasite of protozoa and the cause of Legionnaire's pneumonia (15% mortality) and pontiac fever, and aquatic non-tuberculous Mycobacterium species which may cause pulmonary disease and opportunistic wound infections.

Endotoxins are also a worrisome component of contaminated dental water. Endotoxins are lipopolysaccharides in the cell wall of gram-negative bacteria that can produce a wide range of physiological responses, including localized inflammation, fever and even toxic shock. Since many of the organisms recovered in dental treatment water are gram-negative bacteria, bacterial endotoxins are present. Recently, it was reported that contaminated dental treatment water indeed may contain levels of endotoxin as high as 500 endotoxin units/ml, or EU/ml, with an average of about 80 EU/ml. In comparison, the United States Pharmacopeia, or USP, sets a limit for endotoxin in sterile water for irrigation at only 0.25 EU/ml.

Various protozoa and viruses may also become a part of the biofilm and, because the time from one patient to the next may be very short, the likelihood that pathogenic microbes may survive is high.

Thus, in order to reduce the risk of patient contamination due to backflow, an apparatus was developed. The apparatus comprises any type of check valve or one-way valve. Any type of check valve or one-way valve known to one of skill in the art may be used, however, examples of the one-way valve are set out below.

One embodiment of the check valve is a duckbill valve which prevents backflow of saliva into the vacuum handpiece. The duckbill valve is a one-way valve which allows liquid flow in only one direction with little or no leakage. The duckbill valve may be placed within an adapter which allows for attachment of the vacuum handpiece to the vacuum tubing. This is advantageous, because it allows for easy removal and replacement of the duckbill valve while reusing the more expensive vacuum handpiece. Alternatively, the duckbill valve may be sold as a part of the adapter.

A further embodiment of the check valve is a ball-in-tube-type valve in which in its closed state, a ball rests against an orifice, held there by a spring. The shelf of the orifice has a hole just smaller than the ball. When liquid is not flowing, the ball rests against the hole. When water flows that correct direction it causes the ball to move away from the hole. However, when water flows the wrong way, the ball is pushed against the hole by the water and acts as a check-valve.

However, an advantage of the duckbill valve is that advantageously it is inexpensive, removable, and easily replaceable. This allows the dental professional to replace the valve when needed at a minimum of expense and, thus, ensures compliance. In addition, the duckbill valve possesses the advantage that, upon a reverse of pressure, it immediately closes with little or no leakage.

In one embodiment the check valve is inserted into the adapter/connector. By inserting the valve into the adapter, a reduced variety of sizes needs to be produced to fit the wide variety of evacuators. This makes the valve easily adaptable to any of the dental chair units which were previously manufactured or are presently manufactured. However, in a further embodiment, the duckbill valve is produced to fit within the vacuum handpiece, itself. Although this may require a larger variety of sizes, it would have other advantages.

One embodiment of the check valve, a duckbill valve, will now be described with reference to working embodiments.

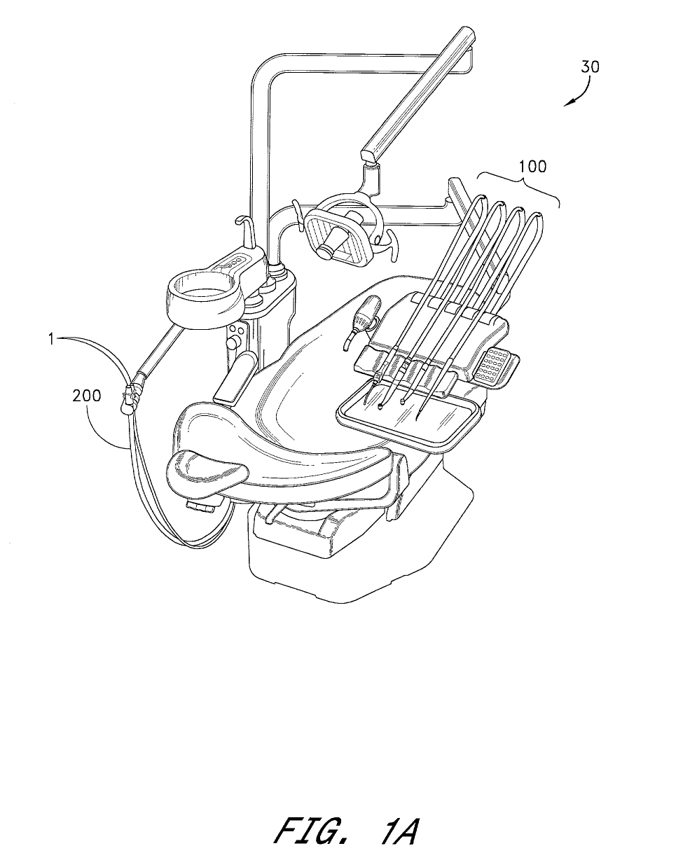

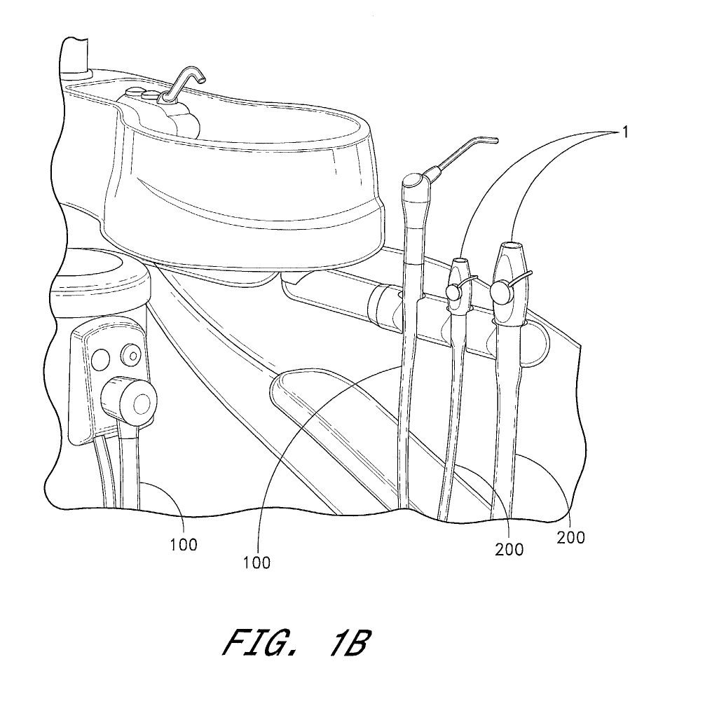

FIGS. 1A and B show a typical dental chair (30) which contains a variety of attachments to vacuum lines (200) as well as a variety of attachments to water lines (100). The water lines (100) and vacuum lines (200) are separated on this particular chair (30), although there are a variety of different chairs (30) available commercially which have alternative set-ups for the water and vacuum lines. The saliva ejectors or dental aspirators (1) are attached to the vacuum lines (200). Typically, before use, the dental worker will attach an ejector tip to the saliva evacuator (1) in preparation for the patient.

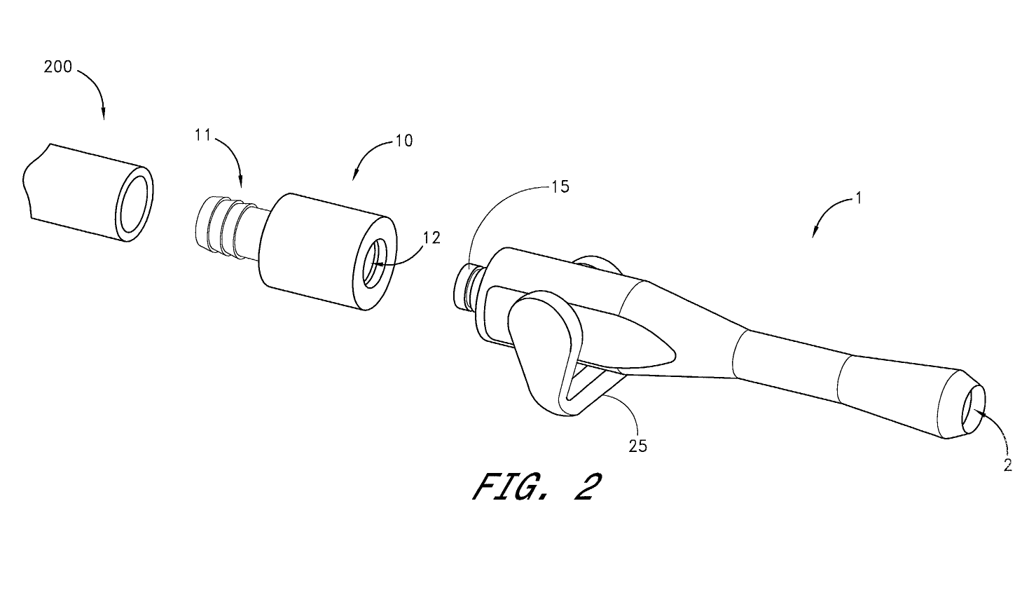

With reference to FIG. 2, the saliva evacuators (1) are typically stainless steel or plastic, autoclaveable, and fit one or more sizes of saliva tubing and tips. They typically have a thermoplastic lever for smooth lever action and a swivel quick disconnect (25). They may also have a connector or adapter (10) which allows them to attach to vacuum tubing (200) at one end. The other end (2) of the saliva evacuator (1) allows for the attachment of saliva tips (ejector tips).

FIG. 2 shows one version of a saliva evacuator (1) also referred to as a vacuum handpiece. When in use, the saliva evacuator (1) may be attached to a tubing adapter/connector (10) and a vacuum tube (200). However, there are a variety of such saliva evacuators which are commercially available and may be larger or smaller. Typically, an adapter/connector (10) may be attached to one end (15) or alternatively, the vacuum tubing (200) may be attached directly. The adapter/connector (10) also has two connection areas, one (11) which allows for attachment of the vacuum tubing (200) and the other (12) which allows for attachment of the saliva evacuator (1).

When in operation, disposable evacuation tips are attached to the tipholder end (2) of the handpiece (1). The saliva evacuator (1) may be directly attached to the vacuum tube (200) or alternatively a tubing adapter (10) can be attached. Problems may occur when the disposable tip is in the mouth of the patient during the process of removing saliva. Various situations may arise which result in the backflow of the saliva into the patient's mouth. It can be envisioned that as saliva is aspirated, microbes from the saliva may attach to the vacuum tube and continue there as a biofilm. Thus, if the saliva flows back into the patient's mouth, it may bring biofilm or other contaminants with it.

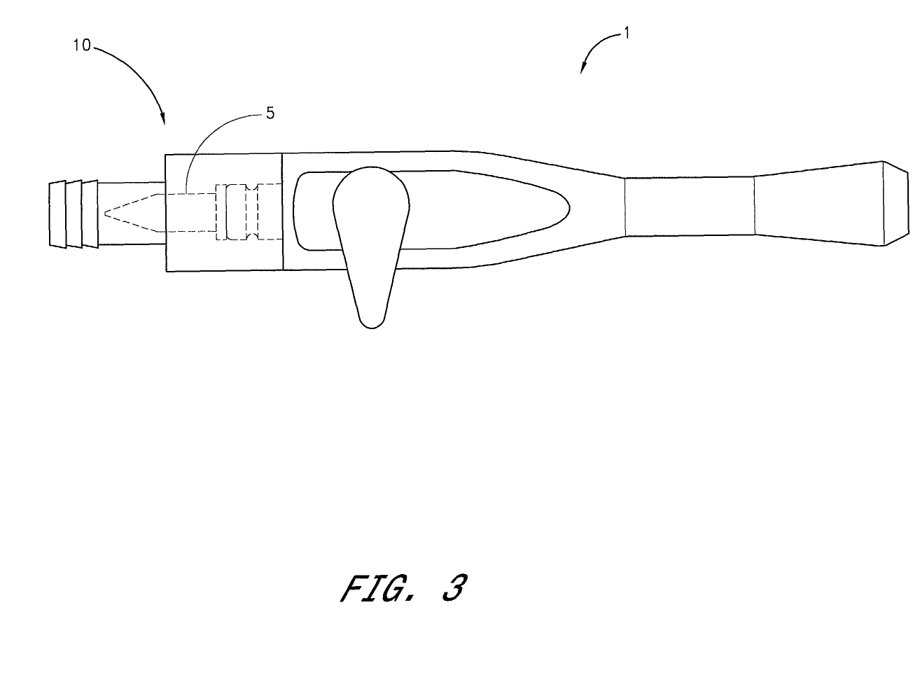

With reference to FIGS. 2 and 3, a preventative apparatus, a duckbill valve (5), is attached within the tubing adapter/connector (10) which may attach to the saliva evacuator (1). In FIG. 3, the tubing adapter/connector (10) is shown attached to the saliva evacuator (1).

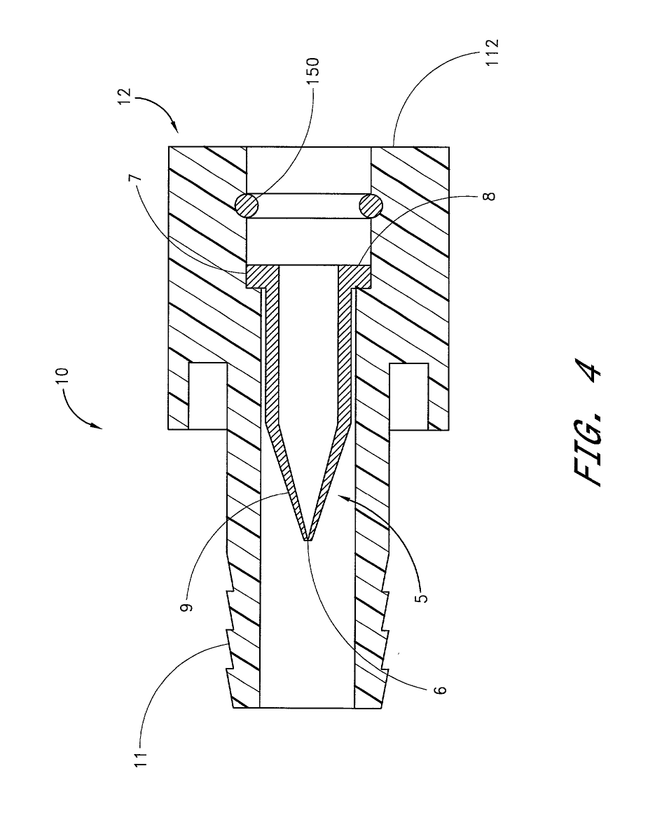

With reference to FIG. 4, the duckbill valve (5) is inserted into the adapter/connector (10) such that there are no gaps for liquid to escape. The adapter/connector (10) typically has one portion (a narrower portion in this embodiment) (11) which allows for attachment to the vacuum tube (200). It also has a second portion (a wider portion in this embodiment) (12) which allows for attachment to the connector (15) of the saliva evacuator (1). The attachment to the adaptor (10) may be internal or external. Either end of the adaptor (10), but particularly the wider end (6) may also have an O-ring (150) which is composed of a softer material and allows for a seal with the saliva evacuator (1).

The embodiment of the duckbill valve (5) shown in FIG. 4 is of a generally V-shape (9) with a rim at one end (7) which allows it to fit into the adapter/connector (10). The duckbill valve (5) then tapers to a narrower portion which contains an opening (6). It can be envisioned that, depending on the adapter (10), the shape may be varied slightly. For example, the rim (7) may be thicker or rounder, and the width of the rim (8) may be wider or longer. The opening (6) in the duckbill valve (5) allows saliva or other liquids to pass freely in the direction from the ejector tip and saliva evacuator (1) toward the vacuum tube (200) or from the patient's mouth into the vacuum tube (200).

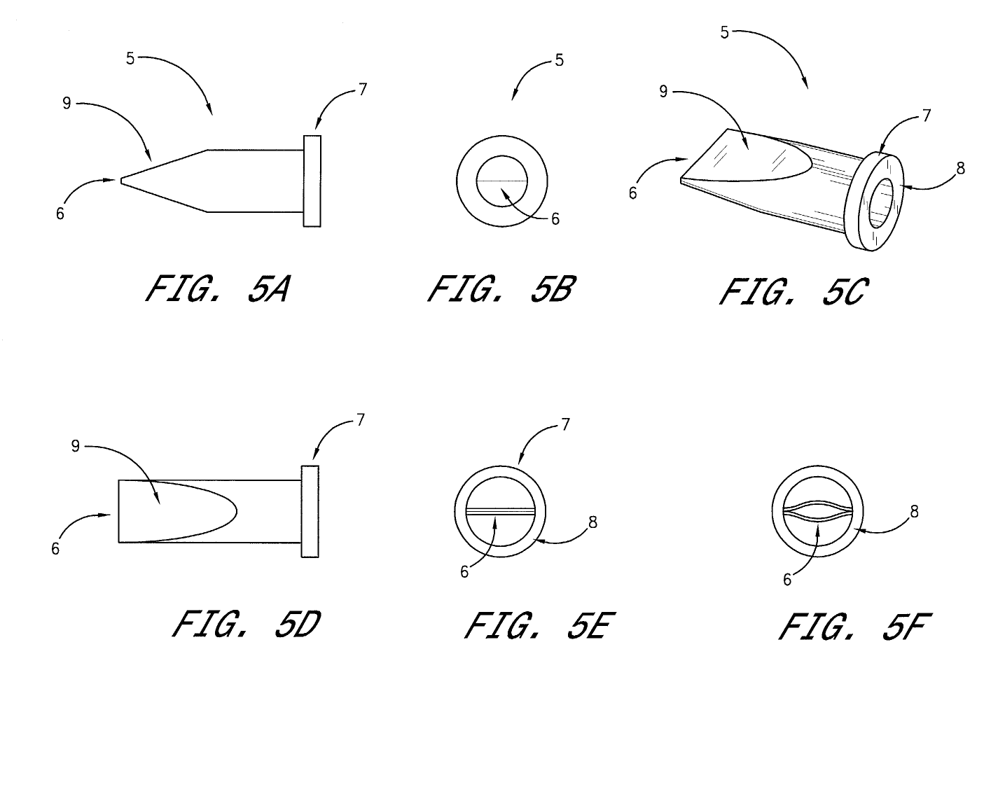

With reference to FIG. 5, the duckbill valve (5) will be described as a working embodiment. In FIGS. 5A-5E the duckbill valve (5) is shown closed. This is the appearance if saliva/liquid were not flowing through it, for example, when the evacuator (1) is not in use. However, this would also be the appearance during a backflow. FIGS. 5A-F show the generally V-shaped duckbill valve (5). The duckbill valve (5) has a rim (7), an opening (6), and two planar sides or ramps (9) which taper down to the opening (6). The opening (6) is produced by the convergence of the two ramps (9). When liquid, including saliva and water, is flowing through the duckbill valve (5) the liquid flows in the direction from the rim (7) to the opening (6) and the opening is pushed open (see FIG. 5F). When aspiration is stopped, the opening (6) returns to its static state, closed (see FIG. 5E). When a change in pressure causes a backflow of the liquid or a directional change of the liquid from the opening (6) to the rim (7), the opening (6) remains closed and no liquid is allowed to flow backwards into the evacuator (1) and into the patient's mouth. Without being restricted to the following theory, the shape of the duckbill valve (5) as well as the material memory keeps water which is flowing backwards from opening the seal formed by the opening (6). The water or liquid exerts pressure on the planar sides or ramps (9) which keeps the opening (6) closed.

The duckbill valve (5) is fashioned of a material which has a memory, such that, when the valve (5) is fashioned larger than the space it fills, it will form a seal and liquid will not pass between the duckbill valve (5) and the adapter/connector (10). Materials which can be used to manufacture the duckbill valve (5) include plastics, polymers, and rubbers or equivalents. The materials may be elastomers such as silicones, soft butyl, hard butyl and other rubbery polymers. The materials may alternatively be nylons, polyesters, epoxies, PTFE, HDPE, PMMA, PVC, PP, PF, PC, and polymides.

It is envisioned that small objects such as pieces of tooth, filling, tissue, and bone may be included as part of the liquid which may be flowing through the duckbill valve (5). Thus, the valve will not allow these objects to pass backwards through the opening (6) into the handpiece (1).

The duckbill valve (5) may be manufactured of a material which is pliable or flexible enough to allow insertion into the adapter/connector (10), but rigid enough that it will have memory and when a backflow occurs and saliva is returned through the duckbill valve (5) in the adapter (10), the material will not collapse. In addition, the material may be slightly sticky allowing for a seal to form between the duckbill valve and the adapter/connector (10).

The duckbill valve (5) is envisioned to be inexpensive and, thus, allow for “disposability”. Thus, after a certain period of use, the valve (5) may be replaced with a new valve (5) at a minimum of expense. In addition, should the valve (5) be damaged, it can easily be replaced with a new valve (5). Depending on the material from which it is manufactured, the valve (5) may require replacement after a longer or shorter time.

It may be of interest to periodically check whether the duckbill valve is working and is in good condition. The condition of the duckbill valve may be tested by creating a vacuum and causing a backflow. Then the amount or appearance of liquid may be analyzed in order to identify whether liquid was able to escape. In addition, a dye may be added to the liquid to aid in detection of leaks. Leakage may occur as the valve becomes older or if it is damaged by a contaminant in the liquid or water being aspirated. Alternatively, microbial tests may be performed to identify whether contaminated liquid is escaping. For example, liquid that leaks may be collected onto an agar surface containing a complete medium, which allows for the growth of many different microbes and, after incubation, may be analyzed for the growth of microorganisms which would constitute contamination.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. An apparatus for preventing a contaminated fluid from entering a patient's mouth through a saliva evacuator, comprising:
a check valve positioned in the fluid flow path of said saliva evacuator, said check valve permitting flow away from said patient's mouth, but not toward said patient's mouth.

2. The apparatus of claim 1 wherein said check valve is a duckbill valve.

3. The apparatus of claim 1 wherein the duckbill valve is manufactured from a material selected from the group consisting of: elastomers, rubbery polymers, nylons, polyesters, PTFE, HDPE, PMMA, PVC, PP, PF, PC, and polymides.

4. The apparatus of claim 3 wherein said elastomer is a silicone.

5. The apparatus of claim 3 wherein said rubbery polymer is soft butyl, or hard butyl.

6. The apparatus of claim 1 wherein said check valve is located at the junction of the sterile and non-sterile portions of said saliva evacuator.

7. A method for preventing contaminated fluid from a dental unit water line from entering a patient's mouth, comprising:
inserting a check valve into a saliva evacuator, such that said check valve permits flow away from but not toward said patient's mouth.

8. The method of claim 7, wherein said check valve is a duckbill valve.

9. The method of claim 8 wherein said duckbill valve is the duckbill valve of claim 1.

10. The method of claim 1 wherein said check valve is located at the junction of the sterile and non-sterile portions of said saliva evacuator.

11. An apparatus for preventing a contaminated fluid from entering a patient's mouth through a saliva evacuator, comprising:
a check valve positioned in the fluid flow path of an adapter attached to said saliva evacuator, said check valve permitting flow away from said patient's mouth, but not toward said patient's mouth.

12. The apparatus of claim 11 wherein said check valve is a duckbill valve.

13. The apparatus of claim 11 wherein the duckbill valve is manufactured from a material selected from the group consisting of: elastomers, rubbery polymers, nylons, polyesters, PTFE, HDPE, PMMA, PVC, PP, PF, PC, and polymides.

14. The apparatus of claim 13 wherein said elastomer is a silicone.

15. The apparatus of claim 13 wherein said rubbery polymer is soft butyl, or hard butyl.

16. The apparatus of claim 11 wherein said check valve is located at the junction of the sterile and non-sterile portions of said saliva evacuator.

17. A method for preventing contaminated fluid from a dental unit water line from entering a patient's mouth, comprising:
inserting a check valve into a saliva evacuator, such that said check valve permits flow away from but not toward said patient's mouth.

18. The method of claim 17, wherein said check valve is a duckbill valve.

19. The method of claim 18 wherein said duckbill valve is the duckbill valve of claim 1.

20. The method of claim 11 wherein said check valve is located at the junction of the sterile and non-sterile portions of said saliva evacuator.
